(19) United States
(12) Patent Application Publication
(10) Pub. No.: US 2024/0140237 A1
(43) Pub. Date: May 2, 2024

(54) CHARGING STATION FOR ELECTRICAL VEHICLES, INCLUDING FUEL BATTERY SYSTEM

(71) Applicant: PETRO WELL SERVICES AS, Ålesund (NO)

(72) Inventors: Vivian LARSGÅRD-INGEBRIGTSEN, Ålesund (NO); Bjørn BJERKE, Ålesund (NO)

(21) Appl. No.: 18/558,613

(22) PCT Filed: May 2, 2022
(86) PCT No.: PCT/NO22/50101

§ 371 Date: Nov. 2, 2023

(30) Foreign Application Priority Data
May 3, 2021 (NO) 20210549
Oct. 28, 2021 (NO) 20211295

(51) Int. Cl. B60L 53/54; B60L 53/31; B60L 53/35; B60L 53/53; H01M 8/04082; H01M 16/00; H02J 3/38

(52) U.S. Cl. CPC B60L 53/54; B60L 53/31; B60L 53/35; B60L 53/53; H01M 8/04201; H01M 16/006; H02J 3/38; B60L 2200/10; B60L 2200/32; H01M 2220/10; H01M 2250/10; H02J 2300/30

(57) ABSTRACT

The present invention concerns a charging station (1) for electrical vehicles. The charging station (1) comprises a storage (2) for liquefied hydrogen, a conversion unit (3) for generating electrical energy with hydrogen from the storage (2), and a battery system (4) for storing electrical energy generated by the conversion unit (3). The charging station (1) also comprises at least one charging pile (5) for charging an electrical vehicle (6) with electrical energy from the battery system (4).

### TECHNICAL FIELD

The present invention is concerned with a charging station for electrical vehicles, a system for charging electrical vehicles, the use of a charging station or a system and a method for charging electrical vehicles.

### BACKGROUND

Electrical vehicles, such as boats, cars, or airplanes, play an important role in the aim to decrease global green-house gas emissions. Driven by governmental incentives and low operational costs, the number of electrical vehicles has risen steadily in recent years. The increasing number of electrical vehicles comes, however, with increased demands on the electrical grid, as many vehicles may require charging simultaneously. Additionally, many modern electrical vehicles are equipped with larger batteries, for an increased range or for powering large vehicles, such as ferries or trucks. Charging of these larger batteries add further to the load on the electrical grid. In addition, there is a general desire to shorten charging times. Long charging times are considered as one of the main downsides of electrical vehicles. To reduce charging times high power chargers are required, typically delivering 200 kW or more. However, the rapid charging delivered by high power chargers places yet another large demand on the electricity grid. Simultaneous charging of many electrical vehicles may therefore place demands exceeding what the electrical grid can handle.

A further issue with the charging of electrical vehicles arises in remote geographical areas. In remote areas there may be insufficient or even lacking electrical infrastructure to handle the charging of electrical vehicles. Furthermore, in densely populated areas with an unreliable electrical grid or an unreliable power supply, charging may be interrupted for longer periods of time. These factors may severely affect electrical mobility and even prevent the use of electrical vehicles, such as electrical cars, in certain geographical areas altogether. Even in areas with a well-developed electrical grid, the increasing demands due to both electrical vehicles and other power-intense activities may lead to failures of the electrical grid. Thereby, the capability for charging of electrical vehicles may be adversely affected.

One solution is to rely on a generator, as a back-up for powering a charging station for electrical vehicles. However, generators normally run on fossil fuels, such as diesel, and thereby contribute heavily to both greenhouse gas emissions and particulate pollution of the surrounding air. Another solution is to directly produce renewable energy at the site of the charging station. However, typical means to directly produce renewable energy rely either on wind power or solar power. Both wind power and solar power require large investments in equipment and infrastructure to generate the required amount of power. Neither the space nor the funding for such structures may be available. Furthermore, these renewable energy sources may not be suitable for all geographical locations and climates.

Consequently, there is a clear need for an improved, emission free charging station, which does not depend on the electrical grid, while still being capable of delivering the high-power output required for rapid charging of all types of electrical vehicles. Furthermore, the charging station should overcome disadvantages of fossil fuel driven electricity generation and of wind-power or solar-power driven electricity generation.

### SUMMARY OF THE INVENTION

The present invention concerns a charging station for electrical vehicles according to claim 1 and a system for charging electrical vehicles according to claim 11. The present invention also concerns the use of a charging station or a system according to claim 12 and a method for charging electrical vehicles according to claim 13.

### FIGURES

FIG. 1 schematically shows a charging station according to first embodiment of the invention.

FIG. 2 schematically shows further details of a charging station according to the invention.

FIG. 3 schematically shows an automated charging system according to the invention.

FIG. 4A schematically shows a charging station according to a second embodiment of the invention.

FIG. 4A schematically shows a top view of a charging station according to the second embodiment of the invention.

FIG. 5 schematically shows a charging station according to a third embodiment of the invention.

### DETAILED DESCRIPTION

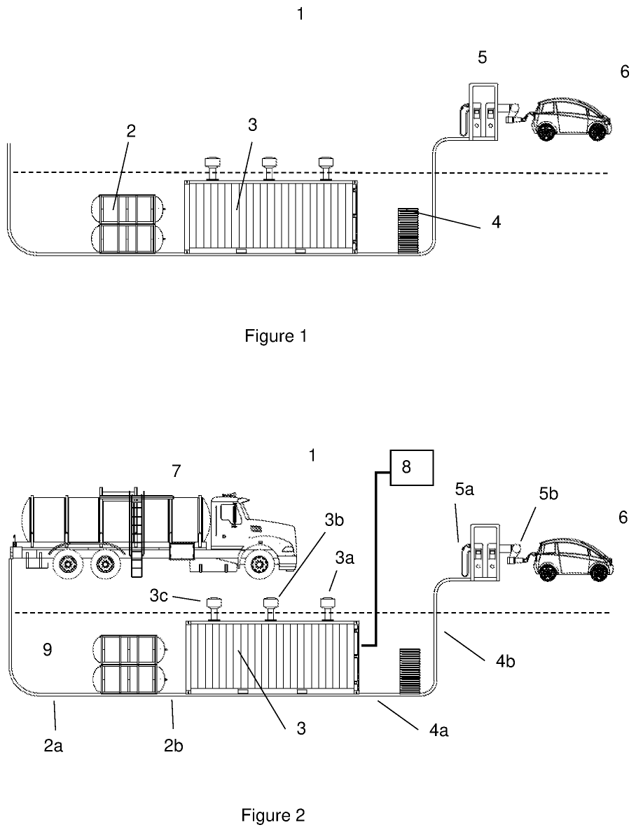

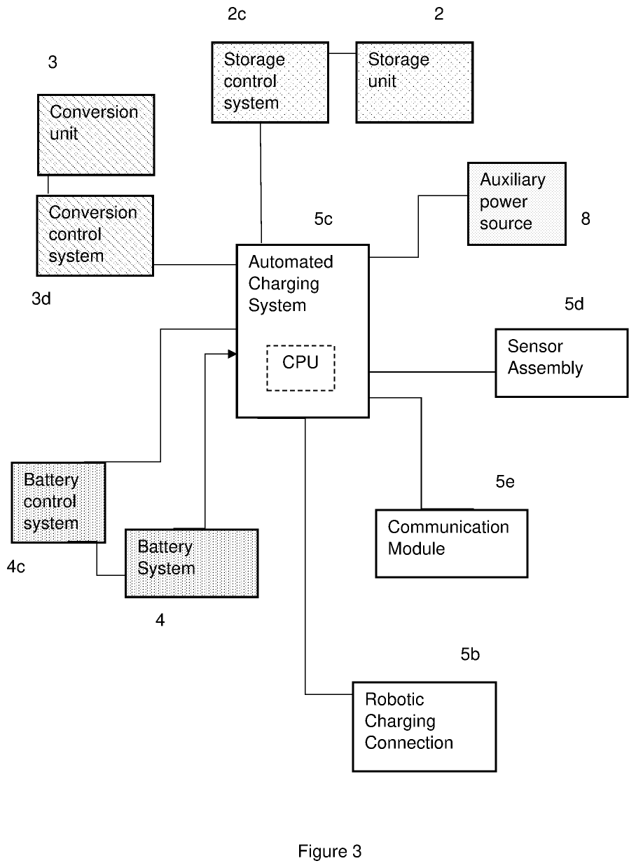

FIG. 1 schematically shows a charging station 1 according to a first embodiment of the invention, for charging an electrical vehicle 6. Further details are schematically shown in FIGS. 2 and 3. Like references denote like elements in FIG. 1, 2, 3 and all other figures. The charging station 1 comprises a storage 2 for liquefied hydrogen and a conversion unit 3 for generating electrical energy from the liquefied hydrogen. Advantageously, liquid hydrogen can be produced elsewhere and then be transported to the charging station with a transport vehicle, analogous to present day charging stations for fossil fuels. Furthermore, liquid hydrogen requires a lower storage volume as compared to pressurized hydrogen in gaseous form. Thereby, both a high efficiency is achieved in the supply chain, as well as a lower demand for storage volume at the charging station. The charging station 1 further comprises a battery system 4 for storing electrical energy from the conversion unit 3. Finally, the charging station 1 comprises at least one charging pile 5 for charging an electrical vehicle 6 with electrical energy from the battery system 4. In the first embodiment, the electrical vehicle 6 may be any type of electrical road vehicle, such as an electrical car, an electrical bus, an electrical motorbike, an electrical truck, an electrical scooter, or an electrical bicycle.

Preferably, the storage 2, conversion unit 3 and battery system 4 are placed belowground. Belowground is understood as including subsurface, in case the surface comprises a man-made structure. The striped line in FIG. 1 and FIG. 2 indicates surface level. The conversion unit 3 and the battery system may utilize DC currents only, with no AC current input or output. Advantageously, the efficiency of the charging station is thereby improved, by avoiding AC-DC conversion. The charging station 1 may have a charging capacity of at least 200 kw, preferably at least 400 kw, more preferably at least 800 kw, most preferably at least 1000 kW. Advantageously, the charging station thereby has sufficient capacity to charge electrical vehicles with high-capacity batteries. Further advantageously, the charging station thereby has sufficient capacity to charge multiple electrical vehicles simultaneously, without experiencing the decrease in charging capacity that a grid-based charging station would experience. The charging station according to the invention can thereby deliver emission free, high-power charging without relying on the electrical grid and without placing a burden on the electrical grid.

Preferably, the storage 2, the conversion unit 3 and the battery system 4 are located belowground. Advantageously, the effects of changes in ambient temperature on the cryogenic storage of liquid hydrogen are thereby reduced. Furthermore, belowground location provides improved protection from the elements for the storage 2, conversion unit 3 and battery system 4. Belowground placement also increases safety for users and operators of the charging station, regarding hydrogen flammability. Finally, by placement belowground, aboveground space requirements are reduced, which is especially advantageous in locations with little available space, such as densely populated areas or mountainous areas with steep terrain. Preferably, a chamber 9 may be provided belowground, to house the storage 2, conversion unit 3 and battery system 4. The chamber 9 may comprise walls, a floor, and possibly a roof, preferably these are all formed of a fire resistant or fireproof material, such as concrete or reinforced concrete. The roof may preferably comprise an access point, allowing access to the chamber 9 for maintenance.

With reference to FIG. 1 and FIG. 2, the storage 2 preferably comprises one or more tanks for liquefied hydrogen. Liquefied hydrogen is stored at a temperature of −252,9° C. or below, at a pressure of 1 bar. Each tank therefore comprises a multi-layer insulation comprising an inner tank suspended in an outer tank. The space between the inner tank and the outer tank may comprise a vacuum. The space around in the storage 2 around the one or more tanks may be filled with an inert gas, such as nitrogen. Thereby, formation of an explosive mixture of hydrogen and air during leakage in the storage may be prevented. The storage 2 further comprises a filling port, through which the storage 2 can be filled with liquid hydrogen, as detailed below. The filling port may be coupled to a first tank. Further tanks may then be coupled to the first tank, such that all tanks can be filled through one filling port. Alternatively, each tank may be provided with a separate filling port, such that each tank of the storage 2 can be filled separately. The storage 2 further comprises a filling pipe 2a. The, or each, filling port is connected to the filling pipe 2a, extending from the storage 2. A vehicle 7, such as a truck for transport of liquid hydrogen, can be coupled to the filling pipe 2a for supplying liquid hydrogen to the storage 2.

The storage 2 further comprises an extraction system, for delivering hydrogen gas from the storage 2 to the conversion unit 3. The extraction system comprises at least one inlet for hydrogen gas, located in the at least one tank of the storage 2. The storage 2 further comprises a storage control system 2c, for controlling the temperature in each tank. The storage control system 2c may comprise at least one sensor and a central processing unit (CPU). The at least one sensor may comprise a temperature sensor and optionally a pressure sensor. By controlling the temperature in each tank, the boil-off of hydrogen gas is controlled, thereby controlling supply of hydrogen gas from the storage 2 to the conversion unit 3. The storage 2 further comprises at least one feed pipe 2b connecting the storage 2 to the conversion unit 3. Hydrogen gas is fed from the storage 2 to the conversion unit 3 through the feed pipe 2b. The feed pipe 2b comprises a shut-off valve, for arresting the flow of hydrogen gas to the conversion unit 3.

The conversion unit 3 comprises a housing. The housing is provided with at least one inlet 3a, for the intake of air from the atmosphere into the conversion unit 3. At least one compressor may be coupled to the at least one inlet 3a, for pressurizing the air. A further compressor may be coupled to the feed pipe 2b, to control the flow of hydrogen gas to and within the conversion unit 3. The conversion unit 3 further comprises at least one fuel cell, for converting hydrogen and oxygen to electrical energy. The fuel cell may comprise a fuel cell stack, comprising a catalyst placed between an anode and a cathode. The at least one fuel cell is coupled to the feed pipe 2b and to the least one inlet 3a. Thereby, hydrogen gas and air may be supplied to the at least one fuel cell. The conversion unit 3 may further comprise a recirculation circuit, for recirculating unconverted hydrogen gas from the fuel cell. Furthermore, the conversion unit 3 may comprise at least one exhaust 3b, for exhausting excess oxygen into the atmosphere. The conversion unit 3 may further comprise at least one cooling inlet 3c, for the inflow of cooling air into the conversion unit 3, the storage 2 and/or the battery system 4. The conversion unit 3 may further comprise a drain, for draining residual water from the fuel cell. The residual water results from the hydrogen conversion process. The conversion unit 3 may further comprise at least one DC-DC converter, coupled to the at least one fuel cell and to the battery system 4. Additionally, the conversion unit 3 may comprise a conversion control system 3d, for controlling the operation of the conversion unit 3. The conversion control system 3d may comprise at least one sensor and a central processing unit (CPU). The at least one sensor may comprise a temperature sensor, a pressure sensor, an optical sensor, or any other suitable sensor. The energy required to drive the conversion unit 3 may be provided by the battery system 4, directly by the fuel cell or by an auxiliary power source 8, detailed below.

The battery system 4 may comprise one or more batteries, preferably large-capacity batteries. The battery system 4 has a charging capacity of at least 100 kw, preferably at least 400 kw, more preferably at least 800 kw, most preferably at least 1000 kW. The battery system 4 is coupled to the conversion unit 3 by one or more power cables 4a. The battery system 4 receives power from the conversion unit 3. The battery system 4 is also coupled to the at least one charging pile 5, with one or more power cables 4b, to provide power thereto. The battery system 4 may comprise at least one, preferably at least two, more preferably at least three batteries for each charging pile 5. Preferably, one battery delivers power to the charging pile 5, one battery provides reserve capacity for the charging pile 5 and one battery can simultaneously be charged by the conversion unit 3. The battery system 4 may comprise one or more additional batteries to drive the conversion unit 3, charging station lighting and/or various control systems. The battery system 4 may further comprise a battery cooling system. The battery cooling system may receive cooling air from the cooling inlet 3c. The battery system 4 may also comprise a battery control system 4c, for controlling operation of the battery system 4. The battery control system 4c may comprise one or more sensors, such as temperature sensors or optical sensors. The battery control system may further comprise a DC-DC converter, and a central processing unit (CPU).

The at least one charging pile 5 is coupled to the battery system 4 with one or more power cables 4b. When coupled to the charging pile 5, an electrical vehicle 6 receives power from the battery system 4, through charging pile 5. Each charging pile 5 may be coupled to at least two batteries of the battery system 4. The charging pile 5 comprises at least one charging connection. Each charging connection is provided with a plug, for coupling to an electrical vehicle 6. The at least one charging pile 5 may be adapted to handle a charging capacity of up to 1000 kW or more. The charging connection may be a manual charging connection 5a. A manual charging connection 5a may be connected to an electrical vehicle 6 by a user or an operator. Alternatively or additionally, the charging station 1 may comprise an automated charging system 5c, schematically shown in FIG. 3. The automated charging system 5c may comprise a central processing unit (CPU). The automated charging system 5c may also comprise a user interface, such as control panel, a tablet or an application running on a smartphone. Advantageously, charging of an electrical vehicle 6 may be performed autonomously, or semi-autonomously by the automated charging system 5c. The automated charging system 5c may comprise a sensor assembly 5d, for the automated recognition of an electrical vehicle 6 and/or for allowing remote operation of the charging station 1. The sensor assembly may include an optical sensor, a radar, a lidar or any other suitable sensor for object recognition and monitoring. The automated charging system 5c may also comprise a communication module 5e, for wireless communication with an electrical vehicle 6 approaching and/or located at the charging station 1. The automated charging system 5c may, for instance, communicate to an approaching electrical vehicle 6 which charging pile 5 is available or will become available shortly. Advantageously, efficient charging of the electrical vehicle 6 may thereby be achieved, with minimal waiting times. The communication module 5e may communicate wirelessly with the electrical vehicle 6 via Wi-Fi, Bluetooth, or short-range radio. The automated charging system 5c may further comprise a robotic charging connection 5b for autonomously connecting the charging pile 5 to an electrical vehicle 6. The robotic charging connection 5b may comprise a robotic arm. The robotic charging connection 5b may be driven and controlled by the automated charging system. The automated charging system 5c preferably controls the robotic charging connection 5b based on data supplied by the machine vision assembly 5d and/or the communication module 5e. The automated charging system 5c may be powered by the at least one battery system 4, an auxiliary power source 8 and/or by the electrical grid. The automated charging system 5c may further control the storage control system 2c, the conversion control system 3d, the battery control system 4c and/or the auxiliary power source 8.

In use, the robotic charging connection 5b automatically connects the charging pile 5 to an electrical vehicle 6 located in the vicinity of the charging pile 5. The electrical vehicle 6 may then be charged with electrical energy from the battery system 4. The communication module 5e may wirelessly receive data from the electrical vehicle 6 indicating the level of charging required. The automated charging system 5c may then instruct the battery control system 4c to deliver the required amount of power to the robotic charging connection 5b. The automated charging system 5c may also instruct the conversion control system 3d to charge, or recharge, the battery system 4 as required. Finally the automated charging system 5c may initiate or stop power supply from the auxiliary power source 8. Advantageously, an optimized operation of the charging station may thereby be achieved. Upon completion of charging, the robotic charging connection 5b may automatically decouple from the electrical vehicle 6. Payment may be performed wireless by the electrical vehicle 6 to the automated charging system or to a remote payment facility, through the communication module 5e.

The automated charging system 5c may comprise machine-readable instructions for controlling operation of the storage control system 2c, the conversion control system 3d, the battery control system 4c, the automated charging system 5c, and/or the auxiliary power source 8. The machine readable instructions may include a self-learning component, such as a neural network, or an artificial intelligence. The self-learning component may be configured to optimize operation and efficiency of the charging station 1. Thereto, the self-learning component may collect data, by monitoring environmental variables, such as ambient temperature, ambient pressure, wind-speed and/or solar radiation. The self-learning component may also monitor charging variables, such as number of vehicles and vehicle battery capacity, over time. Based on the data, the self-learning component may then generate operating instructions utilized by the storage control system 2b, the conversion unit 3, the battery system 4, the automated charging system 5c and/or the auxiliary power source 8. Advantageously, an optimal operation of the conversion unit and an optimal charging cycle for the battery system may thereby be achieved. Further advantageously, optimized charging power and charging times may thereby be achieved for electrical vehicles charging at the charging station. Such optimized charging cycles and charging power may vary over time, such as depending on the season, weekday, or time of day.

The charging station 1 may further comprise an auxiliary power source 8. The auxiliary power source 8 may preferably comprise a renewable energy source, such as an array of solar panels and/or one or more wind turbines. Power from the auxiliary power source 8 may serve as a back-up for charging the at least one battery system 4. Alternatively, or additionally, power from the auxiliary power source 8 may drive non-charging functions of the charging station 1, such as the automated charging system 5c, the conversion unit 3, the storage control system 2c, the conversion control system 3d, the battery control system 4c, and/or charging station lighting.

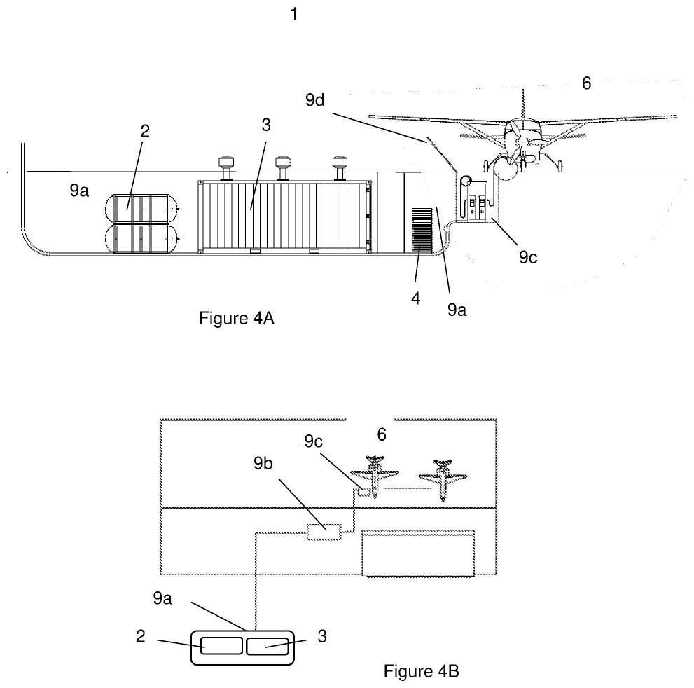

According to a second embodiment of the invention, schematically shown in FIG. 4A, the electrical charging station 1 is located at an aerodrome. The aerodrome may be an airstrip, and airfield, an airport, or a military base. The electrical vehicle 6 may be an electrical airplane, an electrical drone, or an electrical helicopter. In the second embodiment, the chamber 9 may comprise a first chamber 9a, holding the storage 2 and the conversion unit 3. The chamber 9 may further comprise a second chamber 9b, holding the battery 4. The chamber may further comprise a third chamber 9c, holding the charging pile 5. Preferably, the first chamber 9a, the second chamber 9b and the third chamber 9c are located belowground. The third chamber 9c is closeable with a hatch 9d. By placing the charging pile 5 in a chamber belowground, maneuverability of the electrical vehicles at the aerodrome is not impacted. Each of the first chamber 9a, the second chamber 9b and the third chamber 9c are preferably located at some distance from one another, as schematically shown from above in FIG. 4B. Advantageously, a greater level of operational safety is thereby achieved, reducing hazards related to leakage or fire. Alternatively, two or more of the first chamber 9a, the second chamber 9b, and the third chamber 9c, are combined into one chamber.

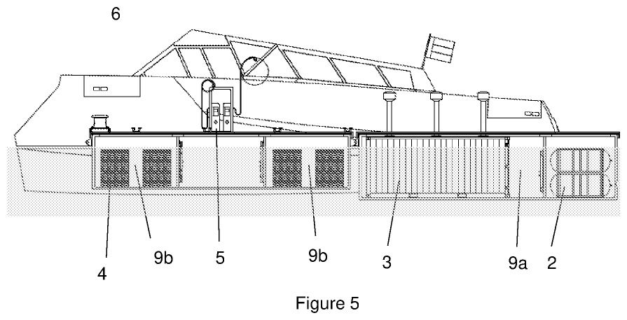

According to a third embodiment of the invention, schematically shown in FIG. 5, the electrical charging station 1 according to the invention is located at a mooring location. The mooring location may be a pier, a pontoon, a quay, a wharf, or a dock. In the third embodiment, the electrical vehicle 6 may be an electrical vessel, an electrical submersible drone, an electrical submarine, an electrical hovercraft, or an electrical seaplane. The chamber 9 may be integrated in the mooring location, as schematically shown in FIG. 5. The chamber 9 may comprise a first chamber 9a, holding the storage 2 and the conversion unit 3. The chamber 9 may further comprise a second chamber 9b, holding the battery 4. Each of the first chamber 9a and the second chamber 9b may be placed belowground. The first chamber 9a and the second chamber 9b may, for instance be integrated in respective parts of a floating pier, as schematically shown in FIG. 5, where the area below the waterline is marked grey. Advantageously, improved temperature control and cooling is thereby achieved and the effects of changes in ambient temperature on the storage of liquid hydrogen are further reduced.

A system for charging electrical vehicles comprises a production facility for liquid hydrogen and at least one charging station 1 according to the invention. The system further comprises at least one transport vehicle 7, such as a cryogenic truck. The production facility produces hydrogen and liquefies the produced hydrogen. The transport vehicle 7 is filled with liquid hydrogen. The transport vehicle 7 may then transport liquid hydrogen from the production facility to the at least one charging station 1. At the charging station 1 the transport vehicle 7 offloads liquid hydrogen to the storage 2. The liquefied hydrogen is supplied to the storage 2 through the filling pipe 2a.

A method for charging an electrical vehicle 6 according to the invention comprises providing a charging station 1 and storing liquefied hydrogen in the storage 2. The method further comprises the step of converting the liquefied hydrogen from the storage 2 to electrical energy in the conversion unit 3 and storing the electrical energy in the battery system 4. The method also comprises the step of charging an electrical vehicle 6 at the charging pile 5 with electrical energy from the battery 4. The step of converting liquefied hydrogen to electrical energy further comprises boiling-off hydrogen gas from the liquefied hydrogen in the storage 2 and feeding the hydrogen gas to the conversion unit 3. The hydrogen gas is fed from the storage 2 to the conversion unit 3 through the feed pipe 2b. The hydrogen gas is converted to electrical energy with a fuel cell comprised in the conversion unit 3 The hydrogen gas is combined with oxygen in the fuel cell to generate electrical energy. The step of charging an electrical vehicle 6 may further comprise autonomously charging an electrical vehicle 6 with the automated charging system 5c. The automated charging system 5c may utilize the robotic charging connection 5b to automatically connect the charging pile 5 to the electrical vehicle 6 and perform autonomous or semi-autonomous charging thereof. Autonomous charging requires no human interaction. Semi-autonomous charging may require some human interaction and be controlled or partially controlled by a user or by an operator. The operator may be at a location remote from the charging station 1. Alternatively or additionally, manual charging may be performed. The electrical vehicle may be a road vehicle, such as an electrical car, an electrical bus, an electrical motorbike, an electrical truck, an electrical scooter, or an electrical bicycle. Alternatively, the electrical vehicle may be an electrical airplane, an electrical drone, or an electrical helicopter. Yet alternatively, the electrical vehicle 6 may be an electrical vessel, an electrical submersible drone, an electrical submarine, an electrical hovercraft, or an electrical seaplane.

### LIST OF REFERENCES

1 charging station
2 storage
2a filling pipe
2b feed pipe
2c storage control system
3 conversion unit
3a inlet
3b exhaust
3c cooling inlet
3d conversion control system
4 battery system
4a power cable
4b power cable
4c battery control system
5 charging pile
5a manual charging connection
5b robotic charging connection
5c automated charging system
5d sensor assembly
5e communication module
6 electrical vehicle
7 transport vehicle
8 auxiliary power source
9 chamber
9a first chamber
9b second chamber
9c third chamber

1. A charging station for electrical vehicles, the charging station comprising:
a storage for liquefied hydrogen;
a conversion unit for generating electrical energy with hydrogen from the storage;
a battery system for storing electrical energy generated by the conversion unit; and
at least one charging pile for charging an electrical vehicle with electrical energy from the battery system.

2. The charging station of claim 1, wherein the storage, the conversion unit, and the battery system, and optionally the at least one charging pile, are placed belowground.

3. The charging station of claim 1, wherein the conversion unit comprises at least one fuel cell.

4. The charging station of claim 1, wherein the battery system comprises multiple batteries and wherein each charging pile is connected to at least two batteries.

5. The charging station of claim 1, further comprising an auxiliary power source, and wherein the auxiliary power source comprises an array of solar panels and/or one or more wind turbines.

6. The charging station of claim 1, further comprising an automated charging system for autonomous or semi-autonomous charging of an electrical vehicle.

7. The charging station of claim 6, wherein the charging pile comprises a robotic charging connection for automated coupling of the charging pile to an electrical vehicle, wherein the robotic charging connection is controlled by the automated charging system.

8. The charging station of claim 6, wherein the automated charging system comprises machine-readable instructions comprising a self-learning component, such as a neural network, or an artificial intelligence.

9. An aerodrome for electrical vehicles, the aerodrome comprising a charging station according to claim 1, wherein the electrical vehicles are electrical airplanes, electrical drones and/or electrical helicopters.

10. A mooring location for electrical vehicles, the mooring location comprising a charging station according to claim 1, wherein the electrical vehicles are electrical vessels, electrical submersible drones, electrical submarines, electrical hovercrafts, and/or electrical seaplanes.

11. System for charging electrical vehicles, the system comprising:
a production facility for producing and liquefying hydrogen;
at least one charging station according to claim 1; and
a transport vehicle for transporting liquefied hydrogen from the production facility to the at least one charging station.

12. Use of a charging station of claim 1, for charging an electrical vehicle, wherein the electrical vehicle is an electrical car, an electrical bus, an electrical motorbike, an electrical truck, an electrical scooter, an electrical bicycle, an electrical airplane, an electrical drone, an electrical helicopter, an electrical vessel, an electrical submersible drone, an electrical submarine, an electrical hovercraft, or an electrical seaplane.

13. A method for charging an electrical vehicle, the method comprising:
providing a charging station of claim 1;
storing liquefied hydrogen in the storage;
converting the liquefied hydrogen to electrical energy in the conversion unit;
storing the electrical energy in the battery system; and
charging an electrical vehicle at the charging pile with electrical energy from the battery.

14. The method according to claim 13, wherein the step of converting liquid hydrogen to electrical energy in the conversion unit comprises:
boiling-off hydrogen gas from the liquefied hydrogen in the storage;
feeding the hydrogen gas to the conversion unit; and
converting the hydrogen gas to electrical energy with a fuel cell comprised in the conversion unit.

15. The method according to claim 13, wherein the step of charging an electrical vehicle is performed autonomously or semi-autonomously.
